(19) United States
(12) Patent Application Publication
(10) Pub. No.: US 2025/0282238 A1
(43) Pub. Date: Sep. 11, 2025

(54) SYSTEMS AND METHODS FOR CONTACTOR CONTROL

(71) Applicant: Dana Heavy Vehicle Systems Group, LLC, Maumee, OH (US)

(72) Inventors: Scott HALL, Commerce Township, MI (US); David HEIN, Sterling Heights, MI (US); Shravan POTTURU, Auburn Hills, MI (US)

(21) Appl. No.: 18/599,957

(22) Filed: Mar. 8, 2024

(51) Int. Cl. B60L 53/16; H02J 7/00

(52) U.S. Cl. CPC B60L 53/16; H02J 7/0042; H02J 7/0047

(57) ABSTRACT

Systems and methods for controlling contactors to evenly distribute wear are disclosed herein. In one example, a method for an electric vehicle having a first charge inlet and a plurality of contactors electrically coupled to the first charge inlet includes, responsive to initiation of a charging event at the first charge inlet, closing at least a portion of contactors of the plurality of contactors according to a first sequence, the first sequence based on a respective accumulated wear of each contactor of the plurality of contactors.

### TECHNICAL FIELD

The present disclosure relates to control of contactors, such as in an electric vehicle.

### BACKGROUND AND SUMMARY

Electric vehicles may make full use of available charging options if the electric vehicles have the capability to utilize different charging configurations, such as combined charging systems (CCSs) and megawatt charging systems (MCSs). However, different charging configurations may not share the same charging station coupler form. To accommodate different charging station coupler forms, an electric vehicle (EV) may include two separate charge inlets. One charge inlet may be adapted to connect with a CCS charging station coupler and another charge inlet may be adapted to connect with a MCS charging station coupler. In a vehicle charging system, contactors may be located within a power distribution unit (PDU) that distributes power from the charge inlets to a battery of the vehicle. Contactors may be used to control the path of the current by switching between open and closed positions that can break or complete the circuit, respectively.

Contactors may include an electromagnet and a set of contacts. When current is delivered to the electromagnet, a magnetic field is generated. The position of the contacts may be adjusted in response to the magnetic field. A contactor can be opened and closed depending on the current supplied to the contactor. In an EV with multiple charge inlets, there may be at least one contactor coupled to the positive terminal and at least one contactor coupled to the negative terminal of each charge inlet.

Contactors can become worn with use, and may degrade under high levels of accumulated wear. Contactor wear can occur when the contactor is changed from an open to closed position or vis versa. When the voltage is not equalized on both sides of an open contactor and the contactor is switched to a closed position, a surge of current to equalize the potential on either side of the contactor may occur, called a current surge. A current surge may degrade a contactor. Wear may also be placed on the contactor when the contactor is opened while current is running through the contactor. In a DC system, any inductance in the system may resist the sudden change in current caused by opening the contactor and produce a voltage spike. A voltage spike may degrade the contactors. Additionally, a contactor may bounce a plurality of times during closing before settling into place, which may cause pitting in the contactor. Pitting may reduce the lifespan of the contactor.

Other attempts to minimize contactor wear include monitoring the amount of current through a contactor to determine how much wear has been applied to the contactor. One example approach is shown by Green et al. in U.S. Pat. No. 11,784,501B2. Therein, the accumulated current through a contactor, temperature of the contactor, and number of times the contactor has been opened and closed may be used to determine a contactor wear parameter. The contactor wear parameter may be considered by a controller and the controller may send an alert to the driver if the contactor has accumulated too much wear and requires maintenance.

However, the inventors herein have recognized potential issues with such systems. As one example, in an electric vehicle charging system with multiple charge inlets and multiple sets of contactors, it is possible for contactors within the system to receive unequal wear. In a vehicle with multiple charge inlets, one charge inlet may be favored due to charge efficiency or the availability of charge stations configured to couple to one of the charge inlets. The favored charge inlet may receive more use, and contactors coupled to the favored inlet may receive more wear. Additionally, fewer contactors may be closed during CCS charging than during MCS charging because of the large current demanded by MCS charging. Differing numbers of contactors in use contributes to unequal contactor wear. Unequal contactor wear may result in a contactor degrading sooner than expected or at an inconvenient time for the vehicle owner, such as when the vehicle owner is trying to charge the vehicle. Thus, it may be possible for the vehicle to become stranded.

Thus, the system described above by Green does not provide a method to distribute the wear on contactors in a system including multiple contactors. In a system with multiple contactors, it is possible for wear to be distributed unevenly between the contactors. Due to uneven contactor wear, some contactors may wear out faster than others and the vehicle may need to be serviced as soon as one contactor wears out. Additionally, in a contactor assembly where the contactors are not arranged in parallel, the degradation of one contactor may make the charging system inoperable.

In one example, the issues described above may be addressed by a method for an electric vehicle including a first charge inlet and a plurality of contactors electrically coupled to the first charge inlet. The method may include closing at least a portion of the contactors of the plurality of contactors according to a first sequence in response to initiation of a charging event at the first charge inlet of the electric vehicle. The first sequence may be based on a respective accumulated wear of each contactor of the plurality of contactors.

As one example, the plurality of contactors may include a first set of contactors having a first polarity and a second set of contactors having a second polarity, all coupled in parallel between one or more batteries of the electric vehicle and the first charge inlet. Closing at least a portion of the contactors according to the first sequence may include identifying that a first contactor of the first set of contactors has a lowest amount of accumulated wear among the plurality of contactors, closing a selected contactor of the second set of contactors, the selected contactor having a lowest amount of accumulated wear among contactors of the second set of contactors, and then closing the first contactor after closing the selected contactor. In this way, the method prioritizes placing wear on the contactor with the lowest amount of accumulated wear during contactor closing. As described above, the contactor that completes the charging circuit during a closing process takes on more wear than the other contactors in the system due to arcing. Closing the contactors according to a method that places arcing wear on the contactor with the lowest amount of accumulated wear distributes the wear equally among the plurality of contactors in the system, which allows the contactors to accumulate similar levels of wear, and extends the lifespan of the contactor system.

It should be understood that the summary above is provided to introduce, in simplified form, a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a diagram of an example electric vehicle with two charge inlets.

FIG. 2 is a diagram of parallel contactors integrated into an electric vehicle charging circuit with two charge inlets.

FIG. 3 is a flowchart depicting a method to determine the accumulated wear on a contactor.

FIG. 4 is a flowchart depicting a method to prioritize placing wear on the least worn contactor during a closing event.

FIG. 5 is a flowchart depicting a method to prioritize placing wear on the least worn contactor during an opening event.

### DETAILED DESCRIPTION

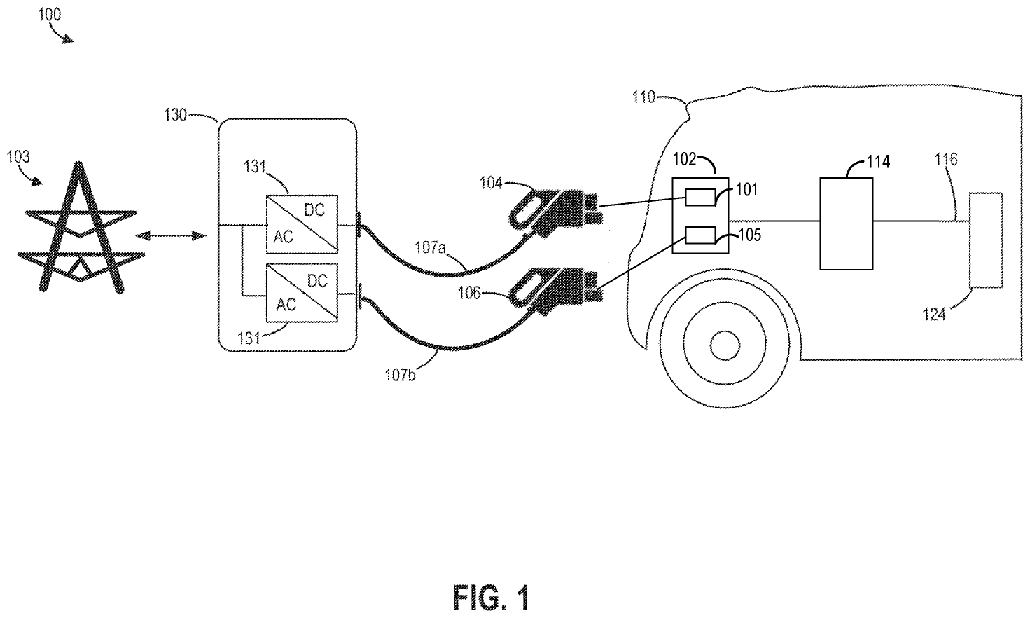

The following description relates to systems and methods for evenly distributing wear on a set of contactors within a charging circuit of an electric vehicle that may have more than one charge inlet or may be otherwise configured to undergo charging at different current demands. For example, electric vehicles may have more than one charge inlet to accommodate multiple different charger configurations, such as a combined charging system (CCS) and a megawatt charging system (MCS), or electric vehicles may have one charge inlet that can accommodate multiple different charger configurations. A diagram of an example of an electric vehicle with two charge inlets connected to a charging system is shown in FIG. 1. The charge inlets may be coupled to a charging circuit located within the vehicle in a power distribution unit (PDU). The positive terminals of the charge inlets may both be coupled to a circuit that includes one or more contactors (e.g., a first set of contactors) arranged in parallel. Similarly, the negative terminals of the charge inlets may both be coupled to a circuit that includes one or more contactors (e.g., a second set of contactors) arranged in parallel. When the vehicle is being charged by an MCS charger, at least two contactors of each polarity may be closed to charge the vehicle. Closing at least two contactors of each polarity allows for an adequate amount of current to flow through the charging circuit. When the vehicle is being charged by a CCS charger, only one contactor of each polarity may be closed due to the lower current involved in CCS charging, and the remaining contactors of each polarity may remain open during charging. In an example charging system with two charge inlets, there may be four contactors: two contactors associated with the negative terminals of the charge inlets and two contactors associated with positive terminals of the charge inlets.

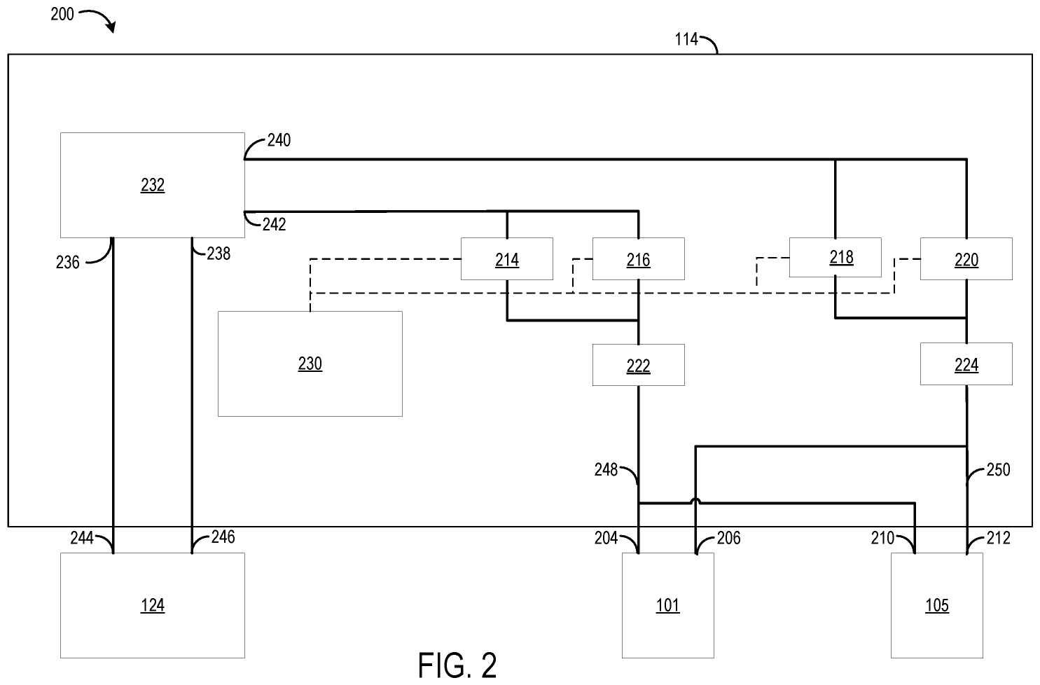

A charging event may be defined as an electric vehicle being coupled to an external power source (e.g., a charging station), the battery of the electric vehicle being recharged, and the vehicle being disconnected from the external power source. The contactors may be directed to close when the vehicle is connected to a charging station, and they may be directed to open when charging has concluded. The contactors may be arranged in parallel to increase current flow through the charging circuit during MCS charging. A parallel contactor arrangement is shown in FIG. 2.

FIG. 2 is a schematic drawing of an example of an electric vehicle charging circuit for a vehicle with two charge inlets, four contactors coupled to the two charge inlets, a controller, and one or more sensors. The controller may be configured to trigger the contactors to open or close in response to a charger (e.g., a plug) being plugged into one of the charge inlets, a charging event concluding, or other potential trigger event. The controller may trigger the operation of the contactors by supplying a flow of current to the contactors. The flow of current may activate an electromagnet within a given contactor, which may open or close the contactor, depending on the contactor model. The sensors may be configured to monitor the current through the contactors, the temperature of the contactors, the number of times the contactor has opened and closed, or additional aspects of the contactors.

To prevent uneven contactor wear, the controller may calculate the amount of accumulated wear on each contactor and determine which contactor has accumulated the lowest amount of wear. Additionally, the level of wear on each contactor may be used to send a notification to the vehicle operator to alert the operator when a contactor is approaching the end of its useful lifespan and thus demands service or replacement.

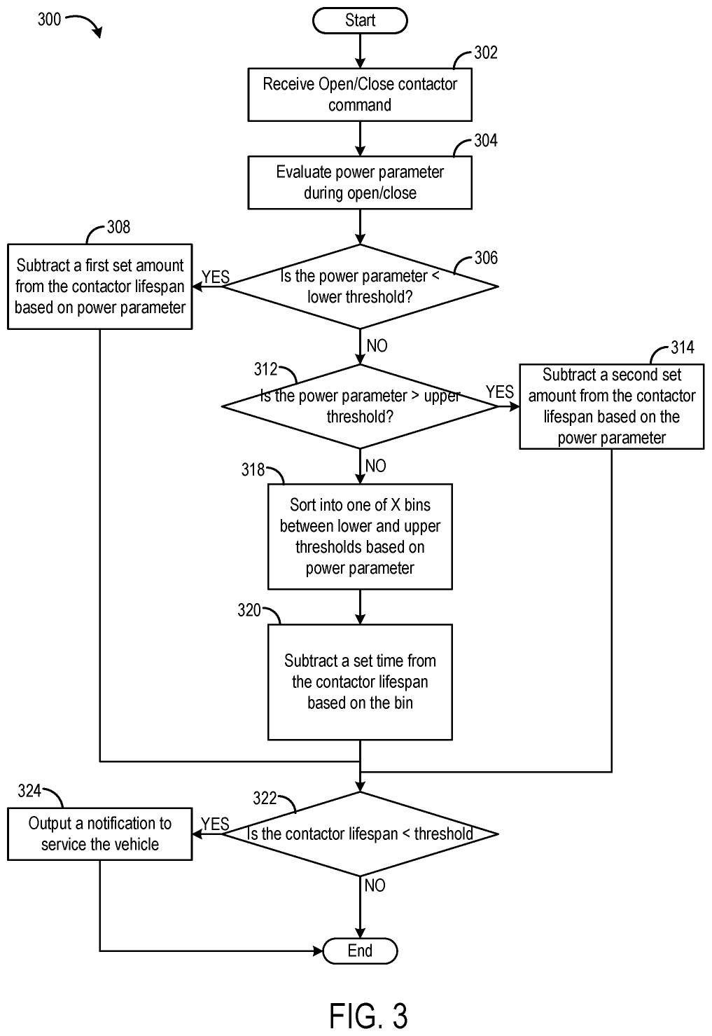

FIG. 3 is a flowchart illustrating a method to determine the remaining useful life of a contactor (e.g., of the vehicle of FIG. 2) based a power parameter. The power parameter may be based on the following factors either alone or in combination: the amount of current passed through the contactor during an opening or closing event, the voltage difference across the contactor during the opening or closing even, or the inductance of the system. Additional factors may include the temperature of the contactor and the number of times the contactor has been opened or closed. If the remaining useful life of a contactor is reduced past a threshold lifespan, the controller may trigger a notification to service the vehicle. The remaining useful life may be used to calculate the amount of accumulated wear on a contactor. The reductions in lifespan applied to the contactor represent additive amounts of wear on the contactor and thus the reduced lifespan of a contactor can be converted to an amount of accumulated wear on the contactor.

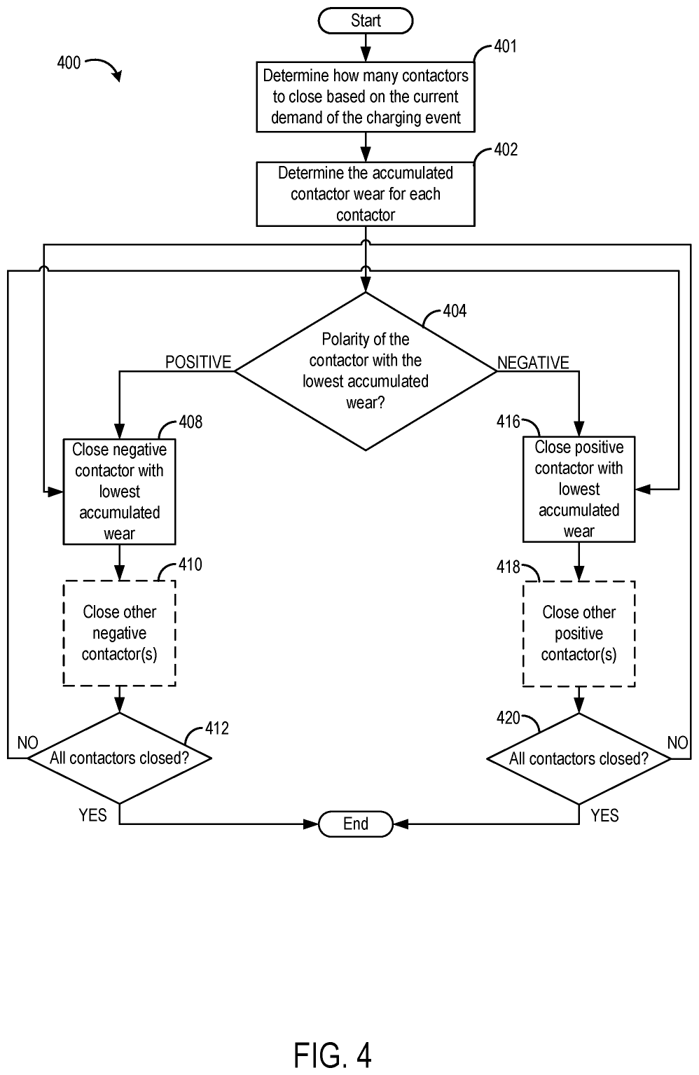

The contactors may be directed to close when the vehicle is connected to a charging station according to a closing sequence that dictates the order in which the contactors are to be closed, in order to facilitate charging. The closing sequence may be arranged so that the least worn contactor is the contactor that, when closed, completes the charging circuit and receives additional wear due to arcing. FIG. 4 is a flowchart illustrating a method by which the controller decides the order in which contactors are to be closed to put wear on the least worn contactor. During a closing event, the polarity of the contactor with the lowest amount of accumulated wear may be determined, and the contactor or contactors of the opposite polarity may be closed first. The contactor with the lowest amount of accumulated wear may then be closed, completing a charging circuit, and may be followed by the other contactors that share the same polarity as the contactor with the lowest amount of accumulated wear. The contactor with the lowest amount of accumulated wear may receive the most wear in the scenario described above due to arcing when a complete circuit is formed.

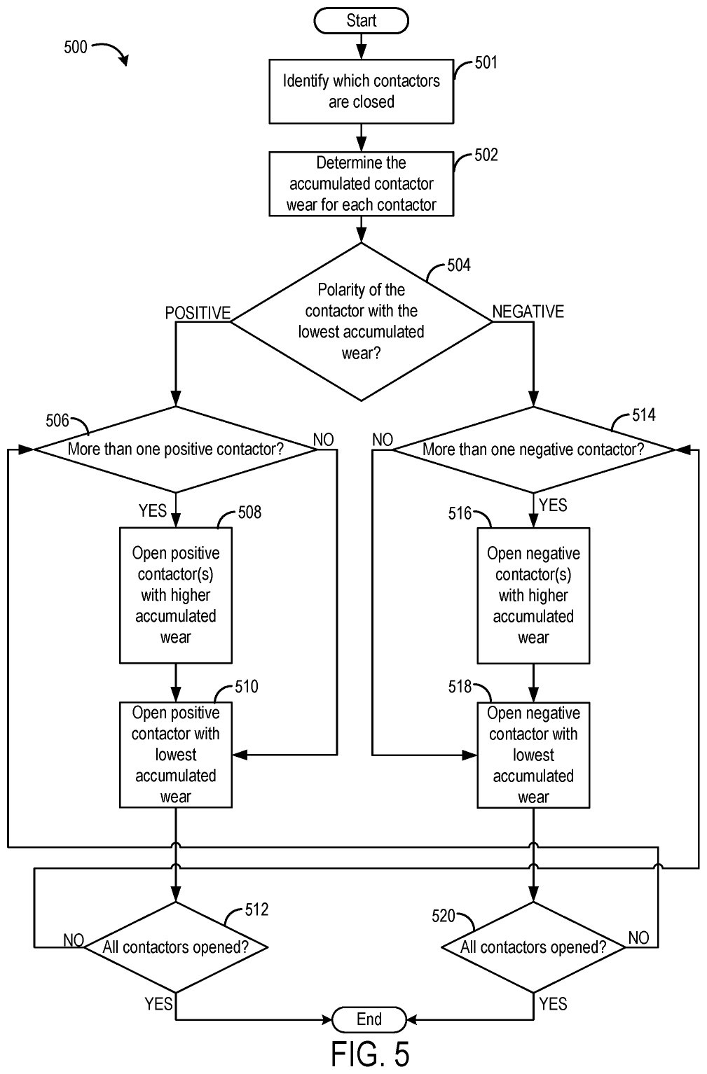

When the vehicle is unplugged from a charging station or the battery is fully charged, the contactors are opened according to an opening sequence that dictates the order in which the contactors are to be opened. The contactor opening sequence may be arranged so that the least worn contactor breaks the circuit and receives wear due to inductive voltage spikes. FIG. 5 is a flowchart illustrating a method by which the controller may decide the order in which contactors are to be opened to put wear on the contactor with the lowest amount of accumulated wear. During an opening event, the opening order may include opening the contactors of the same polarity as the contactor with the lowest amount of accumulated wear first, followed by the contactor with the lowest amount of accumulated wear so the contactor with the lowest amount of accumulated wear is the contactor that breaks the charging circuit due to the possibility for voltage spikes that result from breaking the charging circuit.

The methods described in FIGS. 3, 4, and 5 ensure that excess wear does not accumulate on one contactor in the system and is instead distributed among all contactors in the system. Distributing accumulated wear among all contactors allows the contactors to all approach the end of their useful lifespan at approximately the same time. When one contactor has reached the end of its useful lifespan, the other contactors may also have accumulated similar levels of wear, which allows the lifespan of the contactor system to be maximized and may allow all of the contactors to be serviced at the same time, reducing vehicle service demands and lowering the likelihood a contactor will degrade unexpectedly.

FIG. 1 schematically illustrates a charging configuration 100 for charging a vehicle with two charge inlets. The charging configuration 100 is shown in a simplified form in FIG. 1. The charging configuration 100 may include an energy grid 103 that provides power to the charging configuration 100. The energy grid 103 may derive power from a variety of sources, which may include nuclear power plants, solar panel arrays, wind turbine arrays or other sources. An EV charging station 130 may include an AC to DC converter 131 to convert energy from electric vehicle 110 to energy grid 103 or from energy grid 103 to electric vehicle 110 to charge electric vehicle 110. The EV charging station 130 may be electrically coupled to a battery 124 through a DC output 116 and a PDU 114. The DC output 116 may be an electric vehicle 110. The electric vehicle 110 may be a fully electric vehicle or a hybrid electric vehicle. The electric vehicle 110 may be a car, van, truck, or other vehicle that may be propelled by a motor that may be coupled to a battery 124.

The PDU 114 may direct the flow of charge to and from the battery 124 and may be adapted to protect the battery 124 from current surges during charging. The PDU 114 may include fuses to protect the battery 124, as well as contactors that control the flow of current. Contactors may be capable of opening and closing to interrupt or complete the charging circuit. The contactors may be closed when charging begins and may be opened when the charging is completed or interrupted.

EV charging station 130 electrically couples energy from energy grid 103 to electric vehicle 110 through a first wire 107a and a first charge coupler 104 and/or through a second wire 107b and a second charge coupler 106. The first charge coupler 104 and/or the second charge coupler 106 may be electrically coupled to the DC output 116 via a vehicle charge coupler 102. The vehicle charge coupler 102 may include a first charge inlet 101 adapted to electrically couple to the first charge coupler 104 and a second charge inlet 105 adapted to electrically couple to the second charge coupler 106. In some examples, the first charge coupler 104 may be a charge coupled or a combined charging system (CCS) and the second charge coupler 106 may be charge coupler of a high voltage megawatt charging system (MCS). The first charge coupler 104 may be referred to as a CCS coupler and the second charge coupler 106 may be referred to as a MCS coupler.

In the example that the first charge coupler 104 is a CCS coupler, the first charge inlet 101 may be adapted to accommodate and couple to the CCS coupler. Similarly, in the example that the second charge coupler 106 is an MCS coupler, the second charge inlet 105 may be adapted to accommodate and couple to the MCS coupler. In some examples, the second charge coupler 106 may be preferred over the first charge coupler 104 because MCS charging may allow the battery 124 to reach a full charge faster. However, it may be advantageous to charge the electric vehicle 110 with a combined charging system in some situations. For example, CCS may be used due to limited availability of MCS-compatible charging stations.

FIG. 2 is a schematic representation of a charging system 200 for an electric vehicle (e.g., electric vehicle 110) with multiple charge inlets. Charging system 200 includes aspects shown in FIG. 1, including PDU 114, the first charge inlet 101, and the second charge inlet 105. Each charge inlet may be coupled with an external source of power as shown in FIG. 1. As explained above with respect to FIG. 1, the first charge inlet 101 may be a CCS charge inlet and the second charge inlet 105 may be an MCS charge inlet. The charge inlets may be coupled to the PDU 114 within the electric vehicle 110. The PDU 114 is configured to direct electricity to a battery 124 within the electric vehicle 110. Each charge inlet has a positive and negative terminal: the first charge inlet 101 has a first charge inlet positive terminal 204 and a first charge inlet negative terminal 206 and the second charge inlet 105 has a second charge inlet positive terminal 210 and a second charge inlet negative terminal 212. The first charge inlet positive terminal 204 and the second charge inlet positive terminal 210 are connected via a positive charging circuit 248 that connects the first charge inlet positive terminal 204 and the second charge inlet positive terminal 210 with a positive terminal 242 of additional power electronics 232 (e.g., fuses) within the PDU 114. The first charge inlet negative terminal 206 and the second charge inlet negative terminal 212 are connected via a negative charging circuit 250 that additionally couples the first charge inlet negative terminals 206 and the second charge inlet negative terminal 212 to a negative terminal 240 of the additional power electronics 232 within the PDU 114.

A pair of contactors may be coupled to the positive charging circuit 248. The pair of contactors includes a first positive contactor 214 that may be arranged in parallel with a second positive contactor 216. A first sensor 222 may be coupled to the positive charging circuit 248 and may be arranged in series with the first positive contactor 214 and the second positive contactor 216; however, other arrangements are possible. The first sensor 222 may include a current sensor configured to measure current flowing through the positive charging circuit 248, which may be used to determine the current through the first positive contactor 214 and the second positive contactor 216. In some examples, the first sensor 222 may further include a temperature sensor configured to measure a temperature of the first positive contactor 214 and the second positive contactor 216. In other examples, the first sensor may additionally be configured to measure the voltage difference across the first positive contactor 214 and the second positive contactor 216. The first sensor 222 may be coupled to a controller 230. The first sensor 222 may provide information to the controller 230 that may be related to the performance of the contactors, such as signals indicative of current through the positive charging circuit 248. The controller 230 may include instructions executable to process the information provided by the sensors to calculate the total wear on each contactor and the remaining useful life of each contactor according to a method explained below with respect to FIG. 3.

The first positive contactor 214 and the second positive contactor 216 may be coupled to the controller 230. The controller 230 may issue commands to the contactors to control their position. For example, the controller 230 may direct the first positive contactor 214 and the second positive contactor 216 to open or close. In some examples, the controller 230 may issue open/close commands when a charging event is initiated or has concluded and based on information provided by the first sensor 222 or based upon the total wear on each contactor or the remaining useful life of the contactor calculated by the controller 230.

The negative charging circuit 250 may be assembled in a similar configuration to the positive charging circuit 248. A pair of contactors may be coupled to the negative charging circuit 250. The pair of contactors may include a first negative contactor 218 that may be arranged in parallel with a second negative contactor 220. The negative charging circuit 250 may include a second sensor 224 that may be arranged in series with the first negative contactor 218 and the second negative contactor 220; however, other coupling arrangements are possible. The second sensor 224 includes a current sensor configured to measure current flowing through the negative charging circuit 250. In some examples, the second sensor 224 may further include a temperature sensor configured to measure a temperature of the first negative contactor 218 and the second negative contactor 220. The second sensor 224 may be coupled to the controller 230. The second sensor 224 may provide information to the controller 230 that may be related to the performance of the contactors. The controller 230 may be capable of using information provided by the sensors to calculate the total wear on each contactor and the remaining useful life of each contactor according to the process exemplified in FIG. 3.

The first negative contactor 218 and the second negative contactor 220 may be coupled to the controller 230. The controller 230 may issue commands to the contactors to control the position of each contactor. For example, the controller 230 may direct the first negative contactor 218 and the second negative contactor 220 to open or close. In some examples, the controller may issue open/close commands based on information provided by the second sensor 224 or based upon the total wear on each contactor or the remaining useful life of the contactor calculated by the controller 230.

The additional power electronics 232 may be coupled to the battery 124 within the vehicle. The additional power electronics 232 may have a second positive terminal 236 coupled to a first positive terminal 244 of the battery 124 and the additional power electronics 232 may have a second negative terminal 238 coupled to a first negative terminal 246 of the battery 124. In the example charging system 200, only one battery is shown, but in other examples the vehicle may include two or more batteries. The battery 124 may be charged when both the positive charging circuit 248 and the negative charging circuit 250 are complete. The positive and negative charging circuits are complete when one or more contactors within both the positive charging circuit 248 and the negative charging circuit 250 are in the closed position. The positive and negative charging circuits are incomplete when all contactors within at least one charging circuit are open.

Charging efficiency may be increased by closing both contactors in the positive charging circuit 248 and the negative charging circuit 250 because the parallel contactor configuration in each circuit allows for increased current flow through the charging circuits. In an example where the battery 124 is being charged via an MCS (e.g., the charging event is occurring via the second charge inlet 105), all four contactors may be closed to accommodate the larger amount of current that flows through the contactors during megawatt charging. In an example where the battery 124 is being charged via a CCS (e.g., the charging even is occurring via the first charge inlet 101), one contactor in the positive charging circuit 248 and one contactor in the negative charging circuit 250 may be closed because a smaller amount of current flows through the contactors for a longer period of time in a combined charging system than a megawatt charging system. The discrepancy between the number of contactors closed during charging through different charging systems may contribute to the uneven wear on the contactors.

The system described above with respect to FIG. 2 constitutes one example of a vehicle charging system with multiple charge inlets and parallel contactors. In other examples, the vehicle charging system may include more than two contactors per charge inlet. For example, the vehicle charging system may include three contactors in the positive charging circuit 248 and three contactors in the negative charging circuit 250. In still further examples, the vehicle charging system may only include one charge inlet that is configured to accommodate multiple different charge coupler configurations or otherwise facilitate charging at different current demands. For example, the vehicle charging system may include one charge inlet configured to receive both a CCS coupler and an MCS coupler.

The number of contactors arranged in parallel may impact the upper limit of current available to be passed through the charging circuits. For example, in a vehicle charging system including only one contactor set, the charging circuits may be limited to approximately 800 A, and may be limited to CCS charging. A vehicle charging system including two sets of contactors may be able to charge via MCS chargers and handle currents of up to 2000 A. A vehicle charging system including three sets of contactors may be able to charge via MCS chargers and handle currents of up to 3000 A.

FIG. 3 is a flowchart illustrating a method 300 for determining the remaining useful life of a contactor of a plurality of contactors of a charging system, such as charging system 200 of FIG. 2. Method 300 may be executed for each contactor of the plurality of contactors. In the charging system 200 exemplified in FIG. 2, the method 300 may be executed for the first positive contactor 214, the second positive contactor 216, the first negative contactor 218, and the second negative contactor 220. The remaining useful life of each contactor is determined individually because it is possible for the contactors to experience an uneven distribution of wear. Instructions for carrying out method 300 and the rest of the methods included herein may be executed by a controller, such as controller 230 described above with reference to FIG. 2, based on instructions stored on a memory of the controller and in conjunction with signals received from sensors of the charging system, such as the sensors described above with respect to FIG. 2.

At 302, method 300 includes issuing a command to open or close one or more contactors in a charging system such as the contactors described above with reference to FIG. 2. The controller 230 may issue a command to close a contactor when the vehicle is connected to a charging station such as EV charging station 130 shown in FIG. 1. In some examples, current measurements taken by the first sensor 222, and the second sensor 224 may be used by the controller 230 to determine if the vehicle is connected to the EV charging station 130. The controller 230 may receive a command to open a contactor when the vehicle is disconnected from a charging station such as EV charging station 130, or if the battery 124 is fully charged. In some examples, a sensor may be coupled to the battery 124 that can measure the battery charge level.

At 304, the method 300 includes evaluating the peak power parameter during the open or close event. In a first example, the power parameter may be the peak current through the contactor. The peak current may be determined from the current through the contactor during the open or close event as measured by a current sensor, such as the first sensor 222 of FIG. 2. The peak current may be the maximum current measured through the contactor over a duration of the open or close event. In a second example, additionally or alternatively, the power parameter may be the voltage difference between two sides of the contactor (e.g., the voltage drop) measured by a sensor such as the first sensor 222. In a third example, additionally or alternatively, the power parameter may be the product of the voltage difference between the two sides of the contactor multiplied by the current through the contactor. In further examples, additionally or alternatively, the power parameter may account for the voltage across the contactors, the current through the contactors, the temperature of the contactors, and the inductance of the system.

The power parameter may then be compared to a plurality of values and sorted into a bin of a plurality of bins. Each bin of the plurality of bins may be defined by a range of values between two power parameter boundaries, where one power parameter boundary represents a lower power parameter boundary than the other power parameter boundary. The plurality of bins may encompass a range of power parameters that may be defined by a minimum power parameter threshold that may be referred to as XLow and a maximum power parameter threshold that may be referred to as MidX. XLow may represent a lower limit on the power parameter. In some examples, XLow may be the power parameter value that causes a least amount of wear to the associated contactor. MidX may represent an upper limit of the power parameter. In some examples, MidX may be the power parameter value that causes a maximum amount of wear to the associated contactor.

At 306, the method determines if the power parameter is less than the minimum wear threshold XLow. If the power parameter is less than XLow, at 308 the method includes subtracting a first set amount associated with the XLow power parameter from the current lifespan of the contactor to generate an adjusted lifespan (e.g., an adjusted remaining useful life) of the contactor. The contactor may have a total lifespan that is set during manufacture/installation of the contactor in the charging system (e.g., when the contactor is new). In some examples, the total lifespan may be a total number of cycles of opening and closing the contactor. For example, the total lifespan may include 200,000 opening cycles/events and 200,000 closing cycles/events. In the example that the power parameter represents a peak current, when the peak current is relatively low during the open or close event, such as when the peak current is less than the minimum current threshold, the lifespan of the contactor may be reduced by a first, smaller amount, such as one cycle. As a specific example, at least during an open event, the minimum current threshold may be 50 Amps. In some examples, such as during a close event, the voltage drop across the contactor may be evaluated and compared to a minimum threshold, such as 100V.

If the power parameter is greater than or equal to XLow, the method may include determining if the power parameter is greater than the maximum power parameter threshold MidX at 312. If the power parameter is greater than the maximum power parameter threshold MidX, at 314 the method includes subtracting a second set amount associated with the MidX power parameter from the (current) contactor lifespan to generate the adjusted lifespan. When the power parameter is relatively high during the open or close event, such as when the power parameter is greater than the maximum power parameter threshold, the lifespan of the contactor may be reduced by a second, highest amount, such as an amount that is greater than one cycle.

As a specific example, at least during a close event, the maximum power parameter threshold may be based on a maximum system voltage, which may be 600-1000 V, or more specifically 800 V, in some examples (and thus the maximum current threshold may be calculated based on 800V and a known resistance of the contactor). In an alternative example, the power parameter may be based on the peak current through the contactor. When the peak current is greater than the maximum threshold during a close event where the contactor is closed, 50,000 cycles may be subtracted from the current lifespan. In some examples, during an open event, the power parameter may be a breaking power calculated based on the system voltage and the peak current. When the contactor is opened with maximum breaking power, such as full system voltage (e.g., 800 V) and 2.5 kA, 200,000 cycles may be subtracted from the lifespan.

If the power parameter is not greater than the maximum power parameter MidX, the method may proceed to 318. At 318, the power parameter is sorted into one of a plurality of bins, each bin encompassing a discrete range of power parameter values and marked by upper and lower power parameter boundaries.

A plurality of power parameter boundaries may divide the range of power parameters between XLow and MidX into discrete bins. The power parameter boundaries may be named Mid1, Mid2, Mid3, and so on until the total number of power parameter boundaries has been reached. Each successive power parameter boundary may represent a larger power parameter than the preceding power parameter. For example, Mid2 is a larger power parameter than Mid1 and Mid3 is a larger power parameter than Mid2. In some examples, the total number of power parameter boundaries may be adjusted and the total number of power parameter boundaries may be represented by the letter X. MidX represents the Xth power parameter boundary. Bins may be defined as the range of power parameters between two successive power parameter boundaries. The first bin may have a lower limit defined by XLow and an upper limit defined by Mid1. The second bin may have a lower limit defined by Mid1 and an upper limit defined by Mid2. The third bin may have a lower limit defined by Mid2 and an upper limit defined by Mid3. This pattern continues until the Xth bin. The Xth bin's lower limit is defined by MidX−1 and its upper limit is defined by MidX.

The power parameter may be within the range of a particular bin, and the identity of that bin may be used to subtract a third set amount from the contactor lifespan to calculate an adjusted lifespan at 320. The third set amount is associated with the bin that encompassed the power parameter. For example, for close events, each bin may be assigned a set amount (e.g., number of cycles) that is a function of the voltage across the contactor when the contactor closes, between the minimum voltage (e.g., of 100V) and the maximum voltage (e.g., 800V). The bins may be equal in size and thus increase linearly, while the set amount that the lifespan is reduced by may follow a 1/x shape curve where x is the voltage across the contactor when the contactor closes. In other words, as the voltage across the contactor increases during the close event, the lifespan is reduced by a larger amount. For open events, each bin may be assigned a set amount (e.g., number of cycles) that is a function of the breaking power (e.g., current, voltage, and system inductance). The set amount that the lifespan is reduced may follow an exponential curve, such that the lifespan may be reduced by exponentially larger amounts as the breaking power increases.

At 322, the method may include comparing the adjusted contactor lifespan to a threshold value. The threshold value may represent a contactor lifespan under which it is recommended to service the vehicle, such as 1000 cycles. If the adjusted contactor lifespan is above the threshold at 322, the method 300 ends. If the adjusted contactor lifespan is below the threshold, method 300 proceeds to 324, where the method may include outputting a notification (e.g., to the vehicle operator) that indicates the vehicle is due for service. The notification may include a MIL (malfunction indicator light) or other suitable notification. Additionally, the controller may save a diagnostic code to indicate that the contactor has reached the contactor lifespan threshold.

In an alternative example of method 300, rather than subtract cycles (or time) from a lifespan of the contactor, an amount of wear may be determined each time the contactor is opened and closed as explained above and added to an accumulated wear condition for the contactor. For example, when the contactor is opened or closed while the peak current is less than the minimum current threshold, the amount of wear may be one cycle and the one cycle may be added to the prior accumulated wear to determine an adjusted accumulated wear. The remaining useful life of the contactor (e.g., the current lifespan of the contactor) may be determined by subtracting the accumulated wear condition from the total contactor lifespan. Thus, instead of subtracting a set amount from the lifespan of a contactor based on the power parameter as described above, a wear condition (e.g., amount of wear) may be added to an accumulated wear condition. The accumulated wear condition may track the total amount of wear the contactor has received over its lifespan. Higher power parameters may result in larger amounts of wear. In some examples, a higher power parameter may result from high currents through the contactors, or large voltage differences between the two sides of the contactor. The accumulated wear on a contactor may be used to calculate the useful lifespan of a contactor. In an alternative embodiment, the accumulated wear on the contactor may be compared to a threshold of accumulated wear to determine when the vehicle is due for service. If the accumulated wear on the contactor increases above the threshold amount of wear, then at 324 the method 300 may include outputting the notification that the vehicle is due for service. For example, if the accumulated wear reaches 399,000 cycles (e.g., such that only 1,000 cycles of life are left in the contactor lifespan), the notification may be output.

The accumulated wear (or current lifespan/remaining useful life) may be used to distribute wear to the contactors when the contactors are opened and closed. FIGS. 4 and 5 are flowcharts that illustrate methods to distribute contactor wear. FIG. 4 displays a method to distribute contactor wear during the contactor closing process and FIG. 5 displays a method to distribute contactor wear during the contactor opening process.

The method 400 in FIG. 4 includes determining the polarity of the contactor with the lowest amount of accumulated wear, closing the contactors of the opposite polarity of the least worn contactor first, then closing the contactor with the lowest amount of accumulated wear before the other contactors of the same polarity. The method 400 prioritizes a contactor closing order wherein the contactor with the lowest amount of accumulated wear is the contactor that completes the charging circuit and receives higher levels of wear due to arcing. At least in some examples, method 400 may be executed in response to initiation of a charging event. Initiation of the charging event may be detected based on insertion of a charging station charge coupler into a charge inlet of the electric vehicle and/or based on a scheduled start time for the charging event or a command from a remote computer to initiate the charging event.

The method 400 may be executed by a controller of a charging system, such as controller 230 of charging system 200. Controller 230 may receive information from the first sensor 222, and the second sensor 224 (e.g., current, voltage drop, temperature) and may control the opening and closing of a plurality of contactors of the charging system, such as the first positive contactor 214, the second positive contactor 216, the first negative contactor 218 and the second negative contactor 220.

At 401, the method 400 may include determining how many contactors to close during the charging event. The number of contactors to close may be determined based on the current demand of the charging event. The current demand of the charging event may be determined based on the type of charge inlet that charge is flowing through (e.g., the charge inlet being used to charge the vehicle). For example, if the vehicle is being charged through a CCS inlet such as the first charge inlet 101, the controller may indicate that the charging event has a lower current demand and one contactor in the positive charging circuit 248 and one contactor in the negative charging circuit 250 are to be closed during the method 400. In the example that the vehicle is being charged through an MCS inlet such as the second charge inlet 105, the controller may indicate that the charging event has a higher current demand and at least two contactors in the positive charging circuit 248 and two contactors in the negative charging circuit 250 are to be closed during the method 400. In other examples, the current demand may be based on the charge coupler inserted into the charge inlet, e.g., whether the charge coupler is a CCS coupler or an MCS coupler. The number of contactors selected for closure may henceforth be referred to as the indicated contactors.

At 402, the method 400 may include determining the accumulated wear on each contactor of the plurality of contactors. The accumulated wear may be determined according to method 300 described above with respect to FIG. 3. At 404, the method may include determining which contactor has the lowest amount of wear (or the highest lifespan) and the polarity of the contactor that has the lowest amount of wear. Determining the polarity of the contactor with the lowest amount of wear may include may include comparing the wear levels of each contactor and identifying the contactor with the lowest amount of accumulated wear. The polarity of the charging path to which the contactor with the lowest amount of accumulated wear is coupled may then be identified.

In one example, the contactor with the lowest amount of accumulated wear may be the first positive contactor 214. The first positive contactor 214 is connected to the positive charging circuit 248 and therefore the polarity of the charging path including the contactor with the lowest amount of accumulated wear is positive. If the polarity of the charging path to which the contactor with the lowest amount of accumulated wear is coupled is positive, the method 400 may proceed to 408. At 408, the method may include closing the negative contactor with the lowest accumulated wear among the negative contactors. The negative contactor with the lowest accumulated wear may be the first contactor to be closed. For example, the first negative contactor 218 may be identified as having the lowest accumulated wear among the negative contactors. After the negative contactor with the lowest accumulated wear is closed, the method may optionally continue at 410.

At 410, the method may include closing the remaining negative contactor/contactors indicated for the charging event. In the example that the vehicle is being charged through the CCS inlet, and the negative contactor with the lowest accumulated wear was closed at 408, no additional negative contactors may be closed at 410. If the vehicle is being charged through the MCS inlet, one or more additional negative contactors may be closed at 410.

At 412, the method may include evaluating if all of the indicated contactors have been closed. The number of indicated contactors may be determined by the type of charge inlet being utilized. In the example that the vehicle is being charged through the MCS inlet, at least two contactors from the negative charging circuit 250 and at least two contactors from the positive charging circuit 248 may be closed. In the example that the vehicle is being charged through the CCS inlet one contactor from the negative charging circuit 250 and one contactor from the positive charging circuit 248 may be closed.

Identifying open and closed contactors may be based on feedback (e.g., signals) from sensors such as the first sensor 222 and the second sensor 224 respectively coupled to the positive charging circuit 248 and the negative charging circuit 250. The positive charging circuit 248 includes the first positive contactor 214 and the second positive contactor 216 and the negative charging circuit 250 includes the first negative contactor 218 and the second negative contactor 220. The first positive contactor 214, the second positive contactor 216, the first negative contactor 218 and the second negative contactor 220 and the first sensor 222 and the second sensor 224 may each be coupled to the controller 230. If all of the indicated contactors are closed, the method ends. If all of the indicated contactors are not closed, the method 400 continues at 416.

The method may also progress to 416 from 404 if it is determined that the polarity of the contactor that has the most accumulated wear is negative at 404. At 416, the method may include closing the positive contactor with the lowest accumulated wear among the positive contactors before closing any other positive contactors. If it was determined at 410 that all of the indicated negative contactors have been closed, the first positive contactor to be closed completes the circuit and receives more wear than the other contactors in the system due to arcing during closure.

Following 416, the method optionally includes 418, which includes closing one or more additional positive contactors. As explained above, at least two of contactors of each polarity may be closed when the vehicle is connected to a MCS charger, and one contactor of each polarity may be closed when the vehicle is connected to a CCS charger. Thus, if the vehicle is connected to a CCS charger or a smaller of current is otherwise needed, only the positive contactor with the lowest accumulated wear is closed, and no other contactors are closed at 418. If the vehicle is connected to a MSC charger or a larger amount of current is otherwise needed, one or more additional positive contactors are closed at 418. At 420, the method may include evaluating if all of the indicated contactors have been closed. Identifying open and closed contactors may be accomplished by sensors such as the first sensor 222 and the second sensor 224 respectively coupled to the positive charging circuit 248 and the negative charging circuit 250. The positive charging circuit includes the first positive contactor 214 and the second positive contactor 216 and the negative charging circuit 250 includes the first negative contactor 218 and the second negative contactor 220. The first positive contactor 214, the second positive contactor 216, the first negative contactor 218 and the second negative contactor 220 and the first sensor 222 and the second sensor 224 may each be coupled to the controller 230. If all of the indicated contactors are closed, the method ends. If all of the indicated contactors are not closed, the method 400 continues at 408 according to the method discussed above.

A similar method is used to determine the contactor opening order. However, when opening the contactors, the most wear is placed upon the contactor that breaks the circuit, which is the last contactor of a first polarity to open. FIG. 5 is a flow chart illustrating a method 500 for determining the contactor opening order that prioritizes opening the contactor with the lowest amount of accumulated wear after the other contactors with the same polarity, but before contactors of the opposite polarity.

The method 500 may be executed by a controller such as controller 230. Controller 230 may receive information, such as current through each contactor, voltage drop across each contactor, a temperature of each contactor, etc., from the first sensor 222 and the second sensor 224 and may control the opening and closing of the first positive contactor 214, the second positive contactor 216, the first negative contactor 218, and the second negative contactor 220. At least in some examples, method 500 may be executed in response to conclusion of a charging event. Conclusion of the charging event may be detected based on removal of a charging station charge coupler from a charge inlet of the electric vehicle, based on a charge level of the battery(ies) of the electric vehicle reaching a threshold level, and/or based on a command from a remote computer to conclude the charging event.

At 501, the method 500 may include identifying which contactors are closed. The contactors that are closed may be identified based on feedback from the first sensor 222 and the second sensor 224, The contactors that are closed at 501 are the contactors that are eligible to be opened during method 500. The number of contactors in the closed position at 501 may depend on the number of contactors that were identified to be closed at 401 in method 400 based on the charge inlet in use. For example, if the charging event demanded a lower amount of current due to the CCS charge inlet being used, only two contactors may be closed. If the charging event demanded a higher amount of current due to the MSC inlet being used, four contactors may be closed, or six contactors in examples where the charging system includes six contactors. At 502, the method 500 may include determining the accumulated wear of each contactor (e.g., each closed contactor). The amount of accumulated wear of each contactor may be determined by applying the method 300 displayed in FIG. 3 to each contactor within the system and converting the remaining contactor lifespan to accumulated contactor wear if indicated.

At 504, the method may include determining the polarity of the contactor that has the lowest amount of wear (e.g., among the closed contactors). Determining which contactor polarity has the lowest amount of wear may include comparing the wear levels of each eligible (e.g., closed) contactor and identifying the contactor with the least wear. The controller may then identify the polarity of the contactor with the least wear. If the polarity of the contactor with the lowest accumulated wear is positive, the method 500 may proceed to 506. At 506, the method may include determining if more than one positive contactor in the charging system is closed. The number of closed positive contactors may be determined using feedback from the first sensor 222 and the second sensor 224. If more than one positive contactor is not closed (e.g., if only one positive contactor is closed), method 500 proceeds to 510, which is explained below. If more than one positive contactor in the system is closed, the method may proceed to 508.

At 508, the method may include opening the positive contactor(s) that has the higher accumulated wear (e.g., higher wear than the contactor with the lowest accumulated wear). Because more than one positive contactor is closed and thus eligible to be opened, the positive contactors may be opened in order starting with the most worn positive contactor and ending with the least worn positive contactor. The wear on each contactor determined at 502 may be used to determine the opening order. Thus, at 510, the method may include opening the positive contactor with the lowest accumulated wear. If at least one negative contactor is closed when the positive contactor with the lowest accumulated wear is opened at 510, the positive contactor with the lowest accumulated wear breaks the circuit and the may receive additional wear due to arcing. At 512, the method may include evaluating if all of the contactors are open. The determination of whether or not all the contactors are open may be based on feedback (e.g., signals) from sensors such as the first sensor 222 and the second sensor 224. If all of the contactors in the charging system are open, the method ends. If not all of the contactors are open, the method 500 continues at 514.

Returning to 504, if the polarity of the contactor with the lowest accumulated wear is negative, method 500 proceeds to 514. At 514, the method may include determining if more than one negative contactor in the system is closed. The number of closed negative contactors may be determined using feedback from the first sensor 222 and the second sensor 224. If only one negative contactor is closed, method 500 proceeds 518, which is explained in more detail below. If more than one negative contactor in the system is closed, the method may proceed to 516. At 516, the method may include opening the negative contactor(s) that has higher accumulated wear (e.g., higher than the negative contactor with the least wear). Because more than one negative contactor is eligible to be opened, the negative contactors may be opened in order starting with the most worn negative contactor and ending with the least worn negative contactor. The wear on each contactor determined at 502 may be used to determine the opening order.

At 518, the method may include opening the negative contactor with the lowest accumulated wear. If at least one positive contactor is closed when the negative contactor with the lowest accumulated wear is opened at 510, the negative contactor with the lowest accumulated wear breaks the circuit and the may receive additional wear due to arcing. At 520, the method may include evaluating if all of the contactors in the system are open, which may be performed as explained above. If all of the contactors are open, the method ends. If all of the contactors are not open, the method 500 continues at 506.

Thus, method 400 and method 500 described above provide for closing and opening, respectively, contactors of an electric vehicle charging system of an electric vehicle in an order (e.g., sequence) based the wear of each contactor, which may be determined according to method 300 described above. When a charging event is initiated, such as when a vehicle operator inserts a charging station charge coupler into a charge inlet of the vehicle, a battery of the electric vehicle may be charged by flowing current from the charging station charge coupler to the battery via a PDU of the vehicle. The PDU may include a plurality of contactors coupled in parallel, at least a portion of which may be closed (e.g., moved from an open position to a closed position) in response to the initiation of the charging event in order to facilitate the flow of current to the battery. The contactors that are closed, and the order in which the contactors are closed, are based on the wear of each contactor and the current demanded during the charging event, such that the contactor with the least amount of accumulated wear (e.g., the most remaining useful life) is the contactor that completes the circuit. Thus, when the contactors are closed, the contactor with the least amount of accumulated wear is not the first contactor to be closed; rather, a contactor of the opposite polarity is closed first, and then the contactor with the least amount of accumulated wear is closed. In examples where more than two contactors are closed due to the current demand, all the contactors of the opposite polarity are closed first, and then the contactor with the least amount of wear is closed (followed by the remaining contactors of the same polarity as the contactor with the least amount of wear). It is to be appreciated that during circumstances where two or more contactors have the same, lowest accumulated wear among the plurality of contactors, one of the two or more contactors may be randomly selected and designated as the contactor to complete the circuit.

Conversely, when the contactors are opened (e.g., moved from a closed position to an open position) in response to completion of the charging event, the closed contactor(s) of the same polarity as the contactor that has the least amount of wear (among the closed contactors) but does not have the least amount of wear is opened first, followed by the contactor with the least amount of wear. When only one contactor of each polarity is closed, the contactor with the least accumulated wear is opened first, followed by the contactor of the opposite polarity. When all of the contactors are closed, the contactor(s) with the same polarity as the contactor with the least amount of wear but that has more wear than the contactor with the least amount of accumulated wear is opened first, followed by the contactor with the least amount of accumulated wear, followed by the contactor(s) of the opposite polarity that does not have the least amount of accumulated wear among contactors of the opposite polarity as the least worn contactor, and then finally the contactor with the least accumulated wear among contactors of the opposite polarity to the least worn contactor. It is to be appreciated that during circumstances where two or more contactors have the same, lowest accumulated wear among the plurality of (closed) contactors, one of the two or more contactors may be randomly selected and designated as the contactor to open the circuit.

In this way, responsive to initiation of a charging event at a first charge inlet or a second charge inlet of an electric vehicle, at least a portion of contactors of a plurality of contactors of the electric vehicle may be closed according to a first sequence. The first sequence may be based on a respective accumulated wear of each contactor of the plurality of contactors. The plurality of contactors may include a first set of contactors having a first polarity (e.g., positive) and a second set of contactors having a second polarity (e.g., negative), all coupled in parallel between one or more batteries of the electric vehicle and the first charge inlet and the second charge inlet.

When the charging event is at the first charge inlet (and thus demands a lower amount of current), closing at least the portion of contactors of the plurality of contactors according to the first sequence may include identifying that a first contactor of the first set of contactors has a lowest amount of accumulated wear among the plurality of contactors, and closing a selected contactor of the second set of contactors, and then closing the first contactor after closing the selected contactor. The selected contactor may have a lowest amount of accumulated wear among contactors of the second set of contactors. Responsive to conclusion of the charging event, whichever contactor has the lowest amount of wear is opened first. For example, if the first contactor still has a lower amount of wear than the selected contactor, the first contactor may be opened, and then the selected contactor may be opened after the first contactor is opened. Conversely, if the selected contactor now has a lower amount of wear than the first contactor (e.g., owing to wear on the first contactor during closing of the first contactor), the selected contactor may be opened, and then the first contactor may be opened after the selected contactor is opened.

When the charging event is at the second charge inlet (and thus demands a higher amount of current), closing at least the portion of contactors of the plurality of contactors according to the first sequence may include identifying that a first contactor of the first set of contactors has a lowest amount of accumulated wear among the plurality of contactors, and closing a selected contactor of the second set of contactors. The selected contactor may have a lowest amount of accumulated wear among contactors of the second set of contactors. Then, one or more remaining contactors of the second set of contactors may be closed after the selected contactor is closed. The first contactor may then be closed after the one or more remaining contactors of the second set of contactors are closed, at which point one or more remaining contactors of the first set of contactors may be closed after the first contactor is closed. Responsive to conclusion of the charging event, whichever closed contactor has the lowest amount of wear may be opened first. For example, if the first contactor still has the lowest amount of wear, one or more contactors of the first set of contactors excluding the first contactor may be opened, then the first contactor may be opened after the one or more (other) contactors of the first set of contactors. One or more contactors of the second set of contactors excluding the selected contactor (or whatever contactor of the second set that has the lowest amount of wear) may be opened after the one or more remaining contactors of the first set of contactors are opened, and then the selected contactor may be opened. Conversely, if a different contactor now has a lowest amount of wear, the other contactor of the same polarity may be opened first followed by that contactor and then the contactors of the opposite polarity, as explained above.

The respective accumulated wear of each contactor of the plurality of contactors may be based on, for each contactor, a peak current of that contactor each time that contactor is opened or closed. For example, determining the respective accumulated wear of each contactor may include, for a first contactor of the plurality of contactors: measuring a current of the first contactor while the first contactor is opening or closing based on signals from a current sensor associated with the first contactor; identifying a first peak current of the first contactor while the first contactor is opening or closing based on the measured current; and subtracting a set amount from a lifespan of the first contactor to generate an adjusted lifespan, the set amount based on the first peak current. The accumulated wear of the first contactor may be an inverse of the adjusted lifespan. In other examples, determining the respective accumulated wear of each contactor may include, for a first contactor of the plurality of contactors: measuring a current of the first contactor while the first contactor is opening or closing based on signals from a current sensor associated with the first contactor; identifying a first peak current of the first contactor while the first contactor is opening or closing based on the measured current; and adding a set amount to a previously calculated amount of accumulated wear of the first contactor to generate the accumulated wear of the first contactor, the set amount based on the first peak current.

A technical effect of closing and opening at least a portion of a plurality of contactors in an order based on a respective accumulated wear of each contactor of the plurality of contactors is that the contactor with the least amount of wear may be selected to close the circuit (or open the circuit), thereby taking on more wear than the remaining contactors and, over time, evenly distributing wear among all the contactors.

The disclosure also provides support for a method for an electric vehicle having a first charge inlet and a plurality of contactors electrically coupled to the first charge inlet, comprising: responsive to initiation of a charging event at the first charge inlet, closing at least a portion of contactors of the plurality of contactors according to a first sequence, the first sequence based on a respective accumulated wear of each contactor of the plurality of contactors. In a first example of the method, the plurality of contactors includes a first set of contactors having a first polarity and a second set of contactors having a second polarity, all coupled in parallel between one or more batteries of the electric vehicle and the first charge inlet. In a second example of the method, optionally including the first example, closing at least the portion of contactors of the plurality of contactors according to the first sequence comprises: identifying that only two contactors of the plurality of contactors are to be closed based on a current demand of the charging event, identifying that a first contactor of the first set of contactors has a lowest amount of accumulated wear among the plurality of contactors, and closing a selected contactor of the second set of contactors, the selected contactor having a lowest amount of accumulated wear among contactors of the second set of contactors, and then closing the first contactor after closing the selected contactor, and wherein all remaining contactors of the plurality of contactors are maintained open. In a third example of the method, optionally including one or both of the first and second examples, the method further comprises: responsive to conclusion of the charging event, identifying a closed contactor of the first contactor and the selected contactor that has a lowest amount of accumulated wear relative to the other closed contactor of the first contactor and the selected contactor and opening the identified closed contactor before the other closed contactor is opened. In a fourth example of the method, optionally including one or more or each of the first through third examples, closing at least the portion of contactors of the plurality of contactors according to the first sequence comprises: identifying that at least four contactors of the plurality of contactors are to be closed based on a current demand of the charging event, identifying that a first contactor of the first set of contactors has a lowest amount of accumulated wear among the plurality of contactors, and closing a selected contactor of the second set of contactors, the selected contactor having a lowest amount of accumulated wear among contactors of the second set of contactors, then closing one or more remaining contactors of the second set of contactors after closing the selected contactor, then closing the first contactor after closing the one or more remaining contactors of the second set of contactors, and then closing one or more remaining contactors of the first set of contactors after closing the first contactor. In a fifth example of the method, optionally including one or more or each of the first through fourth examples, the method further comprises: responsive to conclusion of the charging event, identifying a closed contactor of the plurality of contactors that has the lowest amount of accumulated wear relative to the other closed contactors of the plurality of contactors, opening a selected closed contactor that has a same polarity as the identified closed contactor and then opening the identified closed contactor before any remaining closed contactors are opened. In a sixth example of the method, optionally including one or more or each of the first through fifth examples, the method further comprises: determining the respective accumulated wear of each contactor of the plurality of contactors based on, for each contactor, a peak current of that contactor each time that contactor is opened or closed. In a seventh example of the method, optionally including one or more or each of the first through sixth examples, determining the respective accumulated wear of each contactor comprises, for a first contactor of the plurality of contactors: measuring a current of the first contactor while the first contactor is opening or closing based on signals from a current sensor associated with the first contactor, identifying a first peak current of the first contactor while the first contactor is opening or closing based on the measured current, and subtracting a set amount from a lifespan of the first contactor to generate an adjusted lifespan, the set amount based on the first peak current, wherein the accumulated wear of the first contactor is an inverse of the adjusted lifespan. In an eighth example of the method, optionally including one or more or each of the first through seventh examples, determining the respective accumulated wear of each contactor comprises, for a first contactor of the plurality of contactors: measuring a current of the first contactor while the first contactor is opening or closing based on signals from a current sensor associated with the first contactor, identifying a first peak current of the first contactor while the first contactor is opening or closing based on the measured current, and adding a set amount to a previously calculated amount of accumulated wear of the first contactor to generate the accumulated wear of the first contactor, the set amount of time based on the first peak current.

The disclosure also provides support for a system for an electric vehicle, comprising: a first charge inlet, a power distribution unit configured to distribute power from the first charge inlet to one or more batteries, the power distribution unit including a plurality of contactors, and a controller storing instructions in memory executable by one or more processors of the controller to: determine, for each contactor of the plurality of contactors, a respective accumulated wear based on a peak current through each contactor each time that contactor is opened and closed, during initiation of a charging event, close at least a portion of the plurality of contactors according to a first sequence that is based on the respective accumulated wear of each contactor and a current demand for the charging event, and responsive to conclusion of the charging event, open the at least the portion of the plurality of contactors according to a second sequence. In a first example of the system, the plurality of contactors includes a first contactor and a second contactor each having a first polarity and a third contactor and a fourth contactor each having a second polarity. In a second example of the system, optionally including the first example, when the current demand for the charging event is a lower current demand and the first contactor has the lowest accumulated wear of each of the plurality of contactors: the first sequence includes closing the third contactor and then closing the first contactor after the third contactor is closed, the third contactor having a lower accumulated wear than the fourth contactor, and the second sequence includes opening the first contactor and then opening the third contactor after the first contactor is opened. In a third example of the system, optionally including one or both of the first and second examples, when the current demand for the charging event is a higher current demand and the first contactor has the lowest accumulated wear of each of the plurality of contactors: the first sequence includes closing the third contactor, closing the fourth contactor, closing the first contactor after the third contactor and the fourth contactor are closed, and closing the second contactor after the first contactor is closed, the third contactor having a lower accumulated wear than the fourth contactor, and the second sequence includes opening the second contactor, opening the first contactor after the second contactor is opened and then opening the third contactor and the fourth contactor after the first contactor is opened. In a fourth example of the system, optionally including one or more or each of the first through third examples, the respective accumulated wear of each contactor is further determined based on a voltage drop across each contactor each time that contactor is opened and closed and/or based on a breaking power of each contactor each time that contactor is opened, wherein the system further includes a second charge inlet and the power distribution unit is configured to distribute power from the second charge inlet to the one or more batteries, and wherein the current demand is determined based on which of the first charge inlet and the second charge inlet is being used for the charging event.

The disclosure also provides support for a method for an electric vehicle having a first charge inlet and a plurality of contactors electrically coupled to the first charge inlet, the method comprising: determining, for each contactor of the plurality of contactors, a respective accumulated wear based on a peak current through each contactor each time that contactor is opened and closed, detecting that a charging event is being initiated, and in response, closing at least a portion of the plurality of contactors according to a first sequence that is based on the respective accumulated wear of each contactor and a current demand for the charging event, and detecting that the charging event has concluded, and in response, opening the at least the portion of the plurality of contactors according to a second sequence that is based on the respective accumulated wear of each contactor. In a first example of the method, the respective accumulated wear is determined for each contactor further based on a voltage drop across that contactor each time that contactor is opened and closed. In a second example of the method, optionally including the first example, the vehicle includes a second charge inlet electrically coupled to the plurality of contactors, wherein detecting that a charging event is being initiated includes detecting that a charging event with the first charge inlet is being initiated and thus the current demand is a first, lower current demand, and wherein closing at least the portion of the plurality of contactors according to the first sequence includes: closing a first selected contactor that has a lowest accumulated wear of the plurality of contactors, and closing a second selected contactor that has an opposite polarity as a polarity of the first selected contactor, the second selected contactor closed before the first selected contactor is closed, and wherein any remaining contactors of the plurality of contactors are maintained open during the charging event. In a third example of the method, optionally including one or both of the first and second examples, opening at least the portion of the plurality of contactors according to the second sequence comprises identifying which contactor has the lowest accumulated wear of the first selected contactor and the second selected contactor, and opening the identified contactor before opening the remaining contactor of the first selected contactor and the second selected contactor. In a fourth example of the method, optionally including one or more or each of the first through third examples, the vehicle includes a second charge inlet electrically coupled to the plurality of contactors, wherein detecting that a charging event is being initiated includes detecting that a charging event with the second charge inlet is being initiated and thus the current demand is a second, higher current demand, and wherein closing at least the portion of the plurality of contactors according to the first sequence includes: identifying a first selected contactor that has a lowest accumulated wear of the plurality of contactors, closing a second selected contactor and a third selected contactor of the plurality of contactors that each have an opposite polarity as a polarity of the first selected contactor, closing the first selected contactor after the second selected contactor and the third selected contactor are closed, and closing a fourth selected contactor of the plurality of contactors. In a fifth example of the method, optionally including one or more or each of the first through fourth examples, opening at least the portion of the plurality of contactors according to the second sequence comprises identifying which closed contactor has the lowest accumulated wear, identifying a polarity of the closed contactor that has the lowest accumulated wear, opening another closed contactor that also has the identified polarity, and opening the identified closed contactor before opening any remaining closed contactors of the plurality of contactors.

FIGS. 1 and 2 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to plug-in electric hybrid vehicles or non-motive applications such as storage batteries. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for an electric vehicle having a first charge inlet and a plurality of contactors electrically coupled to the first charge inlet, comprising:
responsive to initiation of a charging event at the first charge inlet, closing at least a portion of contactors of the plurality of contactors according to a first sequence, the first sequence based on a respective accumulated wear of each contactor of the plurality of contactors.

2. The method of claim 1, wherein the plurality of contactors includes a first set of contactors having a first polarity and a second set of contactors having a second polarity, all coupled in parallel between one or more batteries of the electric vehicle and the first charge inlet.

3. The method of claim 2, wherein closing at least the portion of contactors of the plurality of contactors according to the first sequence comprises: identifying that only two contactors of the plurality of contactors are to be closed based on a current demand of the charging event; identifying that a first contactor of the first set of contactors has a lowest amount of accumulated wear among the plurality of contactors, and closing a selected contactor of the second set of contactors, the selected contactor having a lowest amount of accumulated wear among contactors of the second set of contactors; and then closing the first contactor after closing the selected contactor, and wherein all remaining contactors of the plurality of contactors are maintained open.

4. The method of claim 3, further comprising responsive to conclusion of the charging event, identifying a closed contactor of the first contactor and the selected contactor that has a lowest amount of accumulated wear relative to the other closed contactor of the first contactor and the selected contactor and opening the identified closed contactor before the other closed contactor is opened.

5. The method of claim 2, wherein closing at least the portion of contactors of the plurality of contactors according to the first sequence comprises: identifying that at least four contactors of the plurality of contactors are to be closed based on a current demand of the charging event; identifying that a first contactor of the first set of contactors has a lowest amount of accumulated wear among the plurality of contactors, and closing a selected contactor of the second set of contactors, the selected contactor having a lowest amount of accumulated wear among contactors of the second set of contactors; then closing one or more remaining contactors of the second set of contactors after closing the selected contactor; then closing the first contactor after closing the one or more remaining contactors of the second set of contactors; and then closing one or more remaining contactors of the first set of contactors after closing the first contactor.

6. The method of claim 5, further comprising responsive to conclusion of the charging event, identifying a closed contactor of the plurality of contactors that has the lowest amount of accumulated wear relative to the other closed contactors of the plurality of contactors, opening a selected closed contactor that has a same polarity as the identified closed contactor and then opening the identified closed contactor before any remaining closed contactors are opened.

7. The method of claim 1, further comprising determining the respective accumulated wear of each contactor of the plurality of contactors based on, for each contactor, a peak current of that contactor each time that contactor is opened or closed.

8. The method of claim 7, wherein determining the respective accumulated wear of each contactor comprises, for a first contactor of the plurality of contactors:
measuring a current of the first contactor while the first contactor is opening or closing based on signals from a current sensor associated with the first contactor;
identifying a first peak current of the first contactor while the first contactor is opening or closing based on the measured current; and
subtracting a set amount from a lifespan of the first contactor to generate an adjusted lifespan, the set amount based on the first peak current, wherein the accumulated wear of the first contactor is an inverse of the adjusted lifespan.

9. The method of claim 7, wherein determining the respective accumulated wear of each contactor comprises, for a first contactor of the plurality of contactors:
measuring a current of the first contactor while the first contactor is opening or closing based on signals from a current sensor associated with the first contactor;
identifying a first peak current of the first contactor while the first contactor is opening or closing based on the measured current; and
adding a set amount to a previously calculated amount of accumulated wear of the first contactor to generate the accumulated wear of the first contactor, the set amount of time based on the first peak current.

10. A system for an electric vehicle, comprising:
a first charge inlet;
a power distribution unit configured to distribute power from the first charge inlet to one or more batteries, the power distribution unit including a plurality of contactors; and
a controller storing instructions in memory executable by one or more processors of the controller to:
determine, for each contactor of the plurality of contactors, a respective accumulated wear based on a peak current through each contactor each time that contactor is opened and closed;
during initiation of a charging event, close at least a portion of the plurality of contactors according to a first sequence that is based on the respective accumulated wear of each contactor and a current demand for the charging event; and
responsive to conclusion of the charging event, open the at least the portion of the plurality of contactors according to a second sequence.

11. The system of claim 10, wherein the plurality of contactors includes a first contactor and a second contactor each having a first polarity and a third contactor and a fourth contactor each having a second polarity.

12. The system of claim 11, wherein when the current demand for the charging event is a lower current demand and the first contactor has the lowest accumulated wear of each of the plurality of contactors:
the first sequence includes closing the third contactor and then closing the first contactor after the third contactor is closed, the third contactor having a lower accumulated wear than the fourth contactor; and
the second sequence includes opening the first contactor and then opening the third contactor after the first contactor is opened.

13. The system of claim 11, wherein when the current demand for the charging event is a higher current demand and the first contactor has the lowest accumulated wear of each of the plurality of contactors:
the first sequence includes closing the third contactor, closing the fourth contactor, closing the first contactor after the third contactor and the fourth contactor are closed, and closing the second contactor after the first contactor is closed, the third contactor having a lower accumulated wear than the fourth contactor; and
the second sequence includes opening the second contactor, opening the first contactor after the second contactor is opened and then opening the third contactor and the fourth contactor after the first contactor is opened.

14. The system of claim 10, wherein the respective accumulated wear of each contactor is further determined based on a voltage drop across each contactor each time that contactor is opened and closed and/or based on a breaking power of each contactor each time that contactor is opened, wherein the system further includes a second charge inlet and the power distribution unit is configured to distribute power from the second charge inlet to the one or more batteries, and wherein the current demand is determined based on which of the first charge inlet and the second charge inlet is being used for the charging event.

15. A method for an electric vehicle having a first charge inlet and a plurality of contactors electrically coupled to the first charge inlet, the method comprising:
determining, for each contactor of the plurality of contactors, a respective accumulated wear based on a peak current through each contactor each time that contactor is opened and closed;
detecting that a charging event is being initiated, and in response, closing at least a portion of the plurality of contactors according to a first sequence that is based on the respective accumulated wear of each contactor and a current demand for the charging event; and
detecting that the charging event has concluded, and in response, opening the at least the portion of the plurality of contactors according to a second sequence that is based on the respective accumulated wear of each contactor.

16. The method of claim 15, wherein the respective accumulated wear is determined for each contactor further based on a voltage drop across that contactor each time that contactor is opened and closed.

17. The method of claim 15, wherein the vehicle includes a second charge inlet electrically coupled to the plurality of contactors, wherein detecting that a charging event is being initiated includes detecting that a charging event with the first charge inlet is being initiated and thus the current demand is a first, lower current demand, and wherein closing at least the portion of the plurality of contactors according to the first sequence includes:
closing a first selected contactor that has a lowest accumulated wear of the plurality of contactors; and
closing a second selected contactor that has an opposite polarity as a polarity of the first selected contactor, the second selected contactor closed before the first selected contactor is closed, and wherein any remaining contactors of the plurality of contactors are maintained open during the charging event.

18. The method of claim 17, wherein opening at least the portion of the plurality of contactors according to the second sequence comprises identifying which contactor has the lowest accumulated wear of the first selected contactor and the second selected contactor, and opening the identified contactor before opening the remaining contactor of the first selected contactor and the second selected contactor.

19. The method of claim 15, wherein the vehicle includes a second charge inlet electrically coupled to the plurality of contactors, wherein detecting that a charging event is being initiated includes detecting that a charging event with the second charge inlet is being initiated and thus the current demand is a second, higher current demand, and wherein closing at least the portion of the plurality of contactors according to the first sequence includes:
identifying a first selected contactor that has a lowest accumulated wear of the plurality of contactors;
closing a second selected contactor and a third selected contactor of the plurality of contactors that each have an opposite polarity as a polarity of the first selected contactor,
closing the first selected contactor after the second selected contactor and the third selected contactor are closed; and
closing a fourth selected contactor of the plurality of contactors.

20. The method of claim 19, wherein opening at least the portion of the plurality of contactors according to the second sequence comprises identifying which closed contactor has the lowest accumulated wear, identifying a polarity of the closed contactor that has the lowest accumulated wear, opening another closed contactor that also has the identified polarity, and opening the identified closed contactor before opening any remaining closed contactors of the plurality of contactors.
